(19) United States
(12) Patent Application Publication
(10) Pub. No.: US 2023/0302738 A1
(43) Pub. Date: Sep. 28, 2023

(54) METHOD FOR OPERATING OR MONITORING AN ADDITIVE MANUFACTURING DEVICE

(71) Applicant: KRONES AG, Neutraubling (DE)

(72) Inventors: Stephanie ALLGEIER, Regensburg (DE); Christian DOBLINGER, Nittenau (DE); Katharina LOERCHER, Deggendorf (DE)

(21) Appl. No.: 18/125,970

(22) Filed: Mar. 24, 2023

(30) Foreign Application Priority Data
Mar. 24, 2022 (DE) DE102022107007.7

(51) Int. Cl. B29C 64/386; B33Y 50/00; G05B 19/4099

(52) U.S. Cl. CPC B29C 64/386; B33Y 50/00; G05B 19/4099; G05B 2219/49023

(57) ABSTRACT

The invention relates, inter alia, to a method for operating an additive manufacturing device. The method includes a transmission of a product identification information, which identifies a manufacturing material product unit, preferably a material filament spool, a container having liquid material, or a container having powdered material. The method furthermore includes a reception of a release information to release the additive manufacturing device in reaction to the transmission of the product identification information.

### CROSS REFERENCE TO RELATED APPLICATIONS

This application claims the benefit under 35 U.S.C. § 119(a) of German Patent Application No. DE 10 2022 107 007.7, filed Mar. 24, 2022 entitled METHOD FOR OPERATING OR MONITORING AN ADDITIVE MANUFACTURING DEVICE, and whose entire disclosure is incorporated by reference herein.

### TECHNICAL AREA

The invention relates to a method for operating an additive manufacturing device. The invention furthermore relates to a method for monitoring operation of an additive manufacturing device. Moreover, the invention relates to a system for executing the method for operating an additive manufacturing device or the method for monitoring an operation of an additive manufacturing device.

### TECHNICAL BACKGROUND

The use of additive manufacturing for the on-location supply of customers with replacement parts or wearing parts has the potential of significantly reducing facility shutdown times and storage costs. For example, the customer can have a corresponding replacement part or wearing part for the facility manufactured additively directly on location when the part is required.

For example, DE 10 2015 006 512 A1 discloses a method for producing replacement parts for a machine for producing packages for a smokable product packaging machine having the following steps: a) encrypting digital production data required for the production of the replacement part, b) transmitting the encrypted production data from a first computing unit, in particular associated with the producer of the machine, to a second computing unit, in particular associated with the user of the machine, via remote data transmission, preferably via a communication network, such as the Internet, c) decrypting the transmitted, encrypted production data, d) producing the replacement part using a replacement part production device, which is assigned to the machine user and comprises a 3D printer, according to the transmitted production data.

The on-location supply of customers with replacement parts or wearing parts by the use of additive manufacturing also has certain risks, however. For example, a customer can confuse the material filament spools when inserting a material filament spool into the additive manufacturing device and can use an incorrect material filament spool having an incorrect material, for example. This can have the result that the additive manufacturing device itself does not function, since the different filaments can require different temperatures, etc., to be printable at all. On the other hand, it can occur that the customer installs an apparently matching component or replacement part in the machine after the additive manufacturing, but the component does not withstand the corresponding influences in the machine, since it was additively manufactured from the wrong material.

The invention is based on the object of providing an improved technology for operating or monitoring an additive manufacturing device, using which the above-mentioned disadvantages can preferably be overcome.

### SUMMARY OF THE INVENTION

The object is achieved by the features of independent claim 1. Advantageous refinements are specified in the dependent claims and the description.

One aspect of the present disclosure relates to a method (for example computer-based) for operating an additive manufacturing device (for example a 3D printer), preferably of a container treatment facility (for example as a replacement part manufacturing device), for additively manufacturing a component. The method includes transmitting a product identification information, which identifies a manufacturing material product unit, preferably a material filament spool, a container having liquid material or a container having powdered material (for example uniquely or batch-related). The method furthermore includes receiving a release information to release the additive manufacturing device in reaction to the transmitting of the product identification information.

The method can advantageously prevent the additive manufacturing device from being operated using the incorrect material or the incorrect manufacturing material product unit. The incorrect manufacturing material product unit can be recognized by the system which receives the product identification information and can be reported back accordingly using the release information. Similarly, it can be recognized by the system which receives the product identification information that the correct manufacturing material product unit is to be used and this is also reported back by means of the release information. It can advantageously thus be ensured that the correct material is used for a component to be manufactured additively, which can have advantageous effects on the component, the product, and/or the production security (e.g., stockkeeping, correct component in the machine, etc.). In addition, the method can assist automated material supply, due to which time and resources may be saved on the user side and it can be ensured that material bottlenecks do not occur. This automated material supply can be assisted in that, due to the assignment of the product identification information to available manufacturing material product units, it is known how many manufacturing material product units are still available to the user.

For example, the product identification information can be transmitted from a first (for example computer) system to a second (for example computer) system.

The release information can preferably be received by the first system, for example transmitted by the second system.

The first system can preferably include a computing infrastructure and/or the additive manufacturing device.

The second system can preferably include a computing infrastructure, a cloud infrastructure, and/or a virtual warehouse.

The first system and the second system can preferably communicate with one another via a communication network (for example the Internet) for data transmission, preferably remote data transmission.

In one exemplary embodiment, the method furthermore includes releasing of the additive manufacturing device for additively manufacturing the component by means of the manufacturing material product unit, which is identified by the product identification information, in dependence on the received release information. The method can optionally furthermore include an additive manufacturing of the component by means of the manufacturing material product unit, which is identified by the product identification information, by the released additive manufacturing device.

The releasing and/or the additive manufacturing can preferably be carried out by means of the first system.

In a further exemplary embodiment, the method furthermore includes inputting, acquiring, or selecting of the product identification information before the transmission of the product identification information. The product identification information can preferably be input or able to be input by means of a user interface. Alternatively or additionally, the product identification information can be acquired or able to be acquired by means of a (for example optical) sensor system (for example of the first system) or a (e.g., RFID, NFC, etc.) communication interface (for example of the first system). Alternatively or additionally, the product identification information can be selected or able to be selected in a user interface (for example of a Web server device of the second system).

The input, acquisition, or selection of the product identification information can preferably take place by means of the first system and/or the second system.

In a further exemplary embodiment, the manufacturing material product unit is selected from a plurality of manufacturing material product units, which are each identified using a product identification information for the (for example unique or batch-related) identification of the respective manufacturing material product unit (e.g., by means of embossing, imprinting, lasering, affixing, tagging, etc.).

In one embodiment, the method furthermore includes selecting of a component to be additively manufactured, which is identified by means of a component identification information (for example uniquely) in a user interface (for example of a Web server device of the second system). Alternatively or additionally, the method furthermore includes transmitting of a component identification information, which identifies (for example uniquely) a component selected for additive manufacturing. Alternatively or additionally, the method furthermore includes transmitting of a component information, which specifies at least one geometry feature and/or at least one material specification feature of a component selected for additive manufacturing. Auxiliary information can thus advantageously be provided, on the basis of which it can be checked whether the selected manufacturing material product unit, which is identified by the product identification information, is suitable for the component planned for additive manufacturing.

The selection of the component to be additively manufactured can preferably be carried out by means of the first system with access to the second system. The component identification information and/or the component information can preferably be transmitted by the first system, for example to the second system.

In a further embodiment, receiving of the release information furthermore takes place in reaction to the selection of the component to be additively manufactured, the transmission of the component identification information, and/or the transmission of the component information.

In a further embodiment, the method furthermore includes transmitting of a material consumption information, which specifies an acquired or estimated material consumption of the manufacturing material product unit during the additive manufacturing of the component from the manufacturing material product unit. Alternatively or additionally, the method can furthermore include transmitting of a production progress information, which specifies a production progress and/or a completion of the component to be additively manufactured. These items of information can advantageously be used to update a virtual or estimated material amount of the manufacturing material product unit in the virtual warehouse.

The material consumption information and/or the production progress information can preferably be transmitted by the first system, for example to the second system.

In a further embodiment, the method furthermore includes receiving of at least one operating parameter (for example manufacturing speed and/or manufacturing temperature) for the operation of the additive manufacturing device in reaction to the transmission of the product identification information and optionally an operation of the additive manufacturing device in dependence on the at least one operating parameter received. The operation of the additive manufacturing device can thus preferably be adapted, for example, optimally to the material of the manufacturing material product units used, which is identified by the product identification information.

A further aspect of the present disclosure relates to a method (for example computer-based) for monitoring an operation of an additive manufacturing device (for example a 3D printer), preferably of a container treatment facility (for example as a replacement part manufacturing device), for additively manufacturing a component. The method includes receiving of a product identification information, which identifies a manufacturing material product unit, preferably a material filament spool or a container having liquid or powdered material (for example uniquely or batch-related). The method furthermore includes checking of the received product identification information and/or at least one information assigned to the received product identification information. Moreover, the method includes transmitting of a release information in dependence on the check. Advantageously, the same advantages may be achieved using the method for monitoring the operation of the additive manufacturing device which were already explained with reference to the method for operating the manufacturing device. This applies accordingly to the preferred exemplary embodiments below, etc.

The product identification information can preferably be received by a second system, preferably transmitted from a first system.

For example, the received product identification information and/or the at least one information assigned to the received product identification information can be checked by means of the second system.

The release information can preferably be transmitted by the second system, for example to the first system.

In one exemplary embodiment, during the checking of the product identification information, the product identification information is checked for reliability, for correspondence with an entry in a list of permissible product identification information, and/or for a presence in a virtual warehouse. It can advantageously be checked in this way whether the product identification information is correct at all, whether the user is authorized at all for using the manufacturing material product unit which is identified by the product identification information, and/or whether the manufacturing material product unit identified by the product identification information is authorized at all.

In a further exemplary embodiment, the method furthermore includes retrieving of an actual product information which is assigned to the received product identification information, preferably from a database, wherein the retrieved actual product information is checked (for example for meeting a predetermined setpoint product information). It can advantageously thus be checked, for example, whether the material, the material type, and/or the material amount of the manufacturing material product unit, which is identified by the product identification information, is suitable for the planned additive manufacturing or not.

The actual product information can preferably be retrieved by means of the second system.

In one embodiment, the checking of the retrieved actual product information includes checking of an actual product material amount information of the actual product information and/or an actual product material specification information of the actual product information.

Preferably, the second system can check the actual product material amount information and/or the actual product material specification information.

In a further embodiment, the checking of the retrieved actual product information takes place with respect to a setpoint (desired) product information, preferably including a setpoint product material amount information and/or a setpoint product material specification information.

In a further embodiment, the method furthermore includes updating of the actual product information, preferably the actual product material amount information, in dependence on the checking and/or the transmitting, receiving of a material consumption information, receiving of a production progress information and/or a setpoint product material amount information. An inventory in the virtual warehouse can thus advantageously be kept up-to-date, for example.

The second system can preferably update the actual product information.

For example, the second system can receive the material consumption information and/or the production progress information, for example from the first system.

In a further embodiment, the method furthermore includes receiving of a component identification information, which identifies (for example uniquely) a component selected for additive manufacturing, and/or a component information, which specifies at least one geometry feature and/or at least one material feature (for example material specification or material amount) of a component selected for additive manufacturing, wherein the setpoint product information is dependent on the received component identification information and/or the received component information (for example is retrieved in dependence thereon). In this way, it is advantageously possible, for example, that it can be checked specifically by component whether the correct material, the correct material type, and/or the correct material amount can be provided by the manufacturing material product unit, which is identified by the product identification information.

The second system can preferably receive the component identification information, for example transmitted by the first system or selected by means of the first system with access to the second system.

The second system can preferably receive the component information, for example transmitted by the first system.

In one embodiment variant, the method furthermore includes transmitting of at least one operating parameter (for example manufacturing speed and/or manufacturing temperature) for operating the additive manufacturing device, wherein the at least one operating parameter is dependent on the received product identification information. An optimum setting of the additive manufacturing device to the material of the manufacturing material product units, which is identified by the product identification information, can thus advantageously be performed.

The second system can preferably transmit the at least one operating parameter, for example to the first system.

In a further embodiment variant, the method furthermore includes transmitting of an inventory information and/or an order request information if an inventory in a virtual warehouse reaches or falls below a specifiable minimum inventory.

The second system can preferably transmit the inventory information or the order request information, for example to the first system.

A further aspect of the present disclosure relates to a method for operating and monitoring operation of an additive manufacturing device. The method can include features of the method disclosed herein for operating an additive manufacturing device and/or the method disclosed herein for monitoring operation of an additive manufacturing device, for example individually or in any combination.

A further aspect of the present disclosure relates to a (for example first or second) system, which is configured to carry out a method as disclosed herein.

A further aspect of the present disclosure relates to multiple systems including a first system and a second system. The first system is configured to carry out a method for operating an additive manufacturing device as disclosed herein. The second system is configured to execute a method for monitoring operation of an additive manufacturing device as disclosed herein.

The first system can preferably be comprised in a container treatment facility, e.g., for producing, cleaning, coating, checking, filling, closing, labeling, printing, and/or packaging containers for liquid media, preferably beverages or liquid foods. For example, the containers can be embodied as bottles, cans, canisters, cartons, small bottles, etc.

Preferably, any information can be transmitted and/or received or can be provided as a data signal.

The above-described preferred embodiments and features of the invention can be combined with one another as desired.

### BRIEF DESCRIPTION OF THE FIGURES

Further details and advantages of the invention are described hereinafter with reference to the appended drawing. In the drawing:

FIG. 1 shows a schematic representation of different material flows and different information flows.

### DETAILED DESCRIPTION OF EXEMPLARY EMBODIMENTS

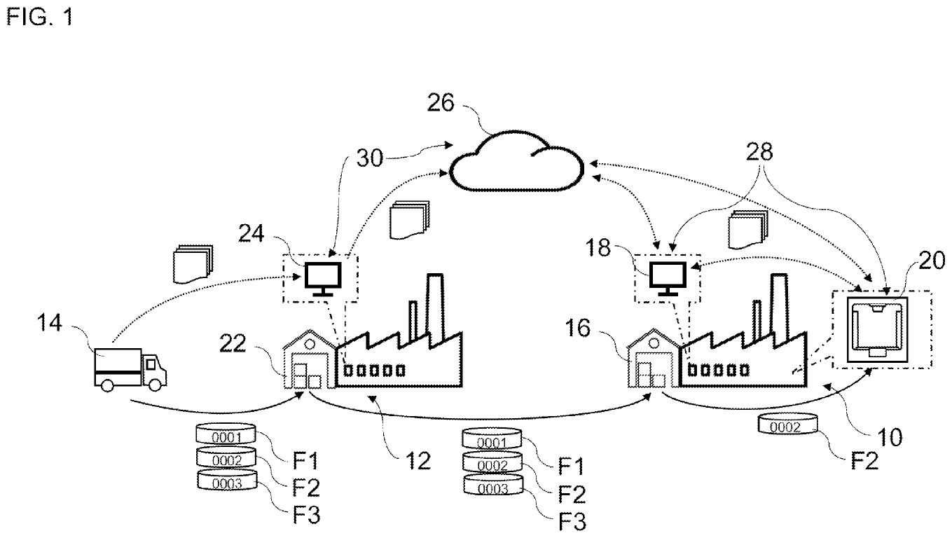

FIG. 1 shows an exemplary application environment. A first industrial facility 10, a second industrial facility 12, and a supplier 14 are shown solely schematically.

In the industrial facility 10, articles can be produced, processed, and/or handled by means of at least one machine. The industrial facility 10 is preferably designed as a container treatment facility for treatment containers.

The industrial facility 10 can have a warehouse 16, a computing infrastructure 18, and an additive manufacturing device 20.

The articles and/or raw materials for this purpose can be stored in the warehouse 16, for example. Moreover, manufacturing material product units F1-F3 for supplying the additive manufacturing device 20 can be stored in the warehouse 16.

The computing infrastructure 18 can include at least one computer, preferably a network (for example local) having multiple computers and optionally at least one server.

Different components can be additively manufactured by means of the additive manufacturing device 20. In additive manufacturing, a component can be manufactured in a large number of material layers lying one on top of another. For example, the additive manufacturing device 20 can be a 3D printer. Material for additively manufacturing the components can be provided to the additive manufacturing device 20 by means of manufacturing material product units F1-F3. Depending on the embodiment of the additive manufacturing device 20, for example, material filament spools, containers having liquid material, or containers having powdered material can be used as manufacturing material product units F1-F3.

Machines or at least assemblies for machines which are used in the industrial facility 10 can be produced in the industrial facility 12. For example, the industrial facility 12 can be designed for producing container treatment devices and/or facilities.

The industrial facility 12 can include a warehouse 22 and a computing infrastructure 24.

Finished machines, finished assemblies, and/or parts for producing the machines or assemblies, for example, can be stored in the warehouse 22.

Moreover, manufacturing material product units F1-F3 for supplying additive manufacturing devices (for example 20) can be stored in the warehouse 22. The manufacturing material product units F1-F3 can be acquired from the supplier 14. Solely by way of example, it is shown in FIG. 1 that the supplier 14 supplies three manufacturing material product units F1-F3 in the warehouse 22 of the industrial facility 12.

The manufacturing material product units F1-F3 preferably differ from one another with respect to a batch number, a material (e.g., BS, PLA, PETG, ASA, nylon, TPE/flex, PVA, HIPS; artificial resin, metals, etc.), a material type (e.g., filament, powder, or liquid), and/or a material amount.

One special feature of the manufacturing material product units F1-F3 is that they are each provided with a product identification. The product identification can be arranged (for example printed, affixed, embossed, lasered, etc.), for example, on a respective container or a package of the manufacturing material product units F1-F3. In the case of material filament spools, for example, the product identification can be arranged on the spool itself. The product identifications can be provided in any form, for example, as alphanumeric codes, barcodes, QR codes, or tags (for example RFID tags), etc.

The respective manufacturing material product unit F1-F3 can be identified by means of the product identification. The manufacturing material product units F1-F3 can preferably be uniquely identified, so that the manufacturing material product units F1-F3 can be uniquely distinguished from one another by means of the respective individual product identification. Alternatively or additionally, for example, a batch-related identification of the manufacturing material product units F1-F3 can be possible by means of the product identifications.

The supplier 14 can transmit the product identifications associated with the supplied manufacturing material product units F1-F3 as product identification information to the computing infrastructure 24. The product identification information can be transmitted as a data set. Further information on the manufacturing material product units F1-F3 can be transferred from the supplier 14 together with the product identification information. These can include, for example, a material specification, a material type, a material amount (for example specified in meters or in grams), and/or a batch number, etc. for the respective manufacturing material product units F1-F3. The computing infrastructure 24 can receive the product identification information and possibly the further information transmitted by the supplier 14.

Alternatively, for example, it is possible that the manufacturing material product units F1-F3 are each provided with the product identification only after the delivery into the warehouse 22. In conjunction therewith, a digital list of manufacturing material product units F1-F3 with their product identifications or product identification information and possibly the further information can be kept in the computing infrastructure 24.

The computing infrastructure 24 can include at least one computer, preferably a network (for example local) having multiple computers and optionally at least one server.

The computing infrastructures 18, 24 can communicate with one another and exchange information directly and/or indirectly, for example via a cloud infrastructure 26. The additive manufacturing device 20 can preferably communicate and exchange information with the computing infrastructures 18 and/or the computing infrastructure 24. The communication can also take place directly and/or indirectly, for example via the cloud infrastructure 26.

To enable a rapid replacement part supply for the machine(s) of the industrial facility 10, replacement parts can be manufactured at least partially directly on location in the industrial facility 10 by means of the additive manufacturing device 20. Preferably in preparation for this, the manufacturing material product units F1-F3 required for this purpose can be delivered into the warehouse 16 of the industrial facility 10, for example after prior ordering. The delivery preferably takes place from the warehouse 22 of the industrial facility 12. Alternatively or additionally, the delivery can also take place, for example, directly from the supplier 14.

Multiple manufacturing material product units F1-F3 can thus be stored in the warehouse 16. Preferably, multiple material filament spools are stored in the warehouse 16, which differ from one another, for example, with respect to a material and/or a material amount. The material filament spools can be distinguishable from one another by their respective separate product identification.

A virtual warehouse for the industrial facility 10 can be stored in the computing infrastructure 24 and/or cloud infrastructure 26. For example, a large number of virtual warehouses for different customers or the industrial facility 10 and further industrial facilities (not shown in FIG. 1) can be stored in the computing infrastructure 24 and/or cloud infrastructure 26.

The product identification information of those manufacturing material product units F1-F3 which were supplied to the warehouse 16 can be stored in the virtual warehouse. In addition, if provided, further information on the manufacturing material product units F1-F3 identifiable by means of the product identification information, for example the material specification, the material type, the material amount, and/or the batch number, can be stored. An overview about all manufacturing material product units F1-F3, which are present in the warehouse 16, can thus be stored in the virtual warehouse. The overview can include unused or unopened manufacturing material product units and already opened or started manufacturing material product units.

Those parts which are to be replaced, for example, due to wear, damage, and/or at regular maintenance intervals preferably come into consideration as replacement parts or components to be additively manufactured.

The component to be additively manufactured is preferably intended for use in an industrial facility 10 designed as a container treatment facility. For example, the component can be a component of a heating device for heating blanks, a production device, preferably a blowing device, for producing containers, a cleaning device, preferably a rinsing device, for rinsing containers, a coating device for coating, preferably internally coating, containers, a filling device for filling containers, preferably with a liquid or pasty medium, a closing device for closing containers, a labeling device for labeling containers, a printing device for printing containers, a packaging device for packaging containers, a grouping device for grouping containers, or a conveyor device, preferably a linear conveyor device or transport star conveyor device, for conveying containers.

The component could particularly preferably be, for example, a gripper or gripper arm for gripping a container, a clamp or a clamp arm for holding a container, a format or trim part, which is adapted to a specific container format, a guide railing, a guide wall, etc.

One special feature of the present disclosure is in the information flows which run for operating and monitoring the additive manufacturing device 20. To operate and monitor the additive manufacturing devices, information can preferably be exchanged between the industrial facilities 10 and 12 or between their computing infrastructures 18, 24 and optional use of the cloud infrastructure 26. In general and as described hereinafter, the information can be exchanged between a first (computer) system 28, which includes the computing infrastructure 18 and/or the additive manufacturing device 20, and a second (computer) system 30, which includes the computing infrastructure 24 and/or the cloud infrastructure 26. The information exchange between the systems 28 and 30 can take place in a wired and/or wireless manner. The information exchange between the systems 28 and 30 can preferably take place via a communication network for data transmission, for example the Internet.

Firstly a corresponding digital file for operating the additive manufacturing device 20 or an authorization for using a digital file already provided can be acquired by a user of the additive manufacturing device 20.

The digital file or the authorization for its use can be transmitted, for example, by the second system 30 to the first system 28 or, for example, with a computing infrastructure of a producer of the additive manufacturing device 20 interconnected or used, can be transmitted to the first system 28. The first system 28 can receive the digital file or the authorization. The digital file can be readable by the additive manufacturing device 20. The digital file can have instructions which prompt the additive manufacturing device 20 to additively manufacture the desired component in a large number of material layers.

For example, a user can select a component to be additively manufactured in an operating interface, for example of a Web server, of the second system 30. The selected component can be identified, preferably uniquely, by means of a component identification or a component identification information. It is also possible that a component identification information which preferably uniquely identifies a component selected for additive manufacturing is transmitted by the first system 28 to the second system 30. The second system 30 can receive the transmitted component identification information. The component identification information can thus be provided in the second system 30 by the selection of the component to be additively manufactured in the operating interface or by the reception of the component identification information. It is also possible that, for example, a component information with respect to a component selected for additive manufacturing is transmitted by the system 28 to the second system 30. The component information can preferably specify at least one geometry feature and/or at least one material specification feature of the component selected for additive manufacturing.

For the additive manufacturing, a suitable manufacturing product material unit, for example the manufacturing product material unit F2, has to be selected from the provided manufacturing product material units F1-F3 and, for example, retrieved from the warehouse 16. The product identification of the selected manufacturing product material unit F2 is transmitted as the product identification information by the first system 28 to the second system 30. The transmission of the product identification information can take place, for example, before or after the connection of the selected manufacturing product material unit F2 to the additive manufacturing device 20.

The product identification information to be transmitted can, for example, be input, acquired, or selected before the transmission. The product identification information can preferably be input by means of a user interface of the first system 28. Alternatively, the product identification information can be acquired, for example, by means of a sensor system (for example optical) of the first system 28 or a communication interface (e.g., RFID, NFC, etc.) of the first system 28. The optical sensor system can acquire, for example, a code, such as a barcode or a QR code, of the selected manufacturing material product unit F2. The communication interface can, for example, acquire or read out an RFID tag of the selected manufacturing material product unit. It is also possible that the product identification information is selected in a user interface, for example of a Web server device, of the second system 30 by means of the first system 28, for example from the virtual warehouse.

The second system 30 receives the transmitted product identification information. After the reception of the product identification information, the second system 30 checks the received product identification information and/or an information assigned to the received product identification information.

In the check of the product identification information, the product identification information can be checked for reliability, for correspondence with an entry in a list of permissible product identification information, and/or for a presence in the virtual warehouse. The product identification information can be permissible, for example, if it is present in the virtual warehouse and/or if it is plausible that the manufacturing product material unit which is identified by the received product identification information has actually previously been acquired by an operator of the industrial facility 10 and, for example, has not yet been consumed. The check of the product identification information for permissibility can alternatively or additionally include a plausibility check with respect to the character sequence of the product identification information.

Alternatively or additionally to the check of the product identification information, at least one information assigned to the product identification information can be checked by the second system 30. For this purpose, for example, an actual product information which is assigned to the received product identification information can be checked.

The actual product information can include, for example, an actual product material amount information and/or an actual product material specification information. The actual product material amount information can specify, for example, how large the current material amount is of the manufacturing material product unit (for example F2), which is identified by the product identification information. The actual product material specification information can specify, for example, a material and/or a material type of the manufacturing material product unit (for example F2), which is identified by the product identification information. The actual product information can be retrieved, for example, from a database of the second system 30 and/or from the virtual warehouse.

The second system 30 can check the actual product information with respect to a setpoint product information. The setpoint product information can be dependent on the component identification information (for example received or provided in the second system 30) and/or the received component information.

For example, the component identification information can be assigned a setpoint product material amount information. The setpoint product material amount information can specify how large a required material amount is for additively manufacturing the component which is identified by the component identification information. When checking the actual product material amount information for fulfilling the setpoint product material amount information, the second system 30 can check whether the selected manufacturing material product unit (for example F2) still has a sufficiently large material amount to completely manufacture the component selected for additive manufacturing.

Alternatively or additionally, the component identification information can be assigned a setpoint product material specification information. The setpoint product material specification information can specify the material from which the component, which is identified by the component identification information, is to be additively manufactured. When checking the actual product material specification information for fulfillment of the setpoint product material specification information, the second system 30 can check whether the selected manufacturing material product unit (for example F2) includes the correct material for the component selected for the additive manufacturing, for example, a predetermined plastic and/or a predetermined artificial resin.

In dependence on the check, the second system 30 transmits a release information to the first system 28. Depending on the results of the check, the release information can include, for example, that the additive manufacturing device 20 is released or not released or blocked for manufacturing the desired component.

It is possible that the second system 30, in addition to the transmission of the release information, transmits at least one operating parameter for operating the additive manufacturing device 20 to the first system 28. The at least one operating parameter can be dependent on the received product identification information. For example, the at least one operating parameter can be retrieved from a database in dependence on the received product identification information. The at least one operating parameter can include, for example, a manufacturing speed and/or a manufacturing temperature (for example for melting the material of the manufacturing material product unit for the additive manufacturing). The at least one operating parameter can be adapted to the material of that manufacturing material product unit (for example F2), which is identified by the received product identification information.

The first system 28 can receive the release information and optionally the at least one operating parameter in reaction to the transmission of the product identification information and optionally in reaction to the selection of the component to be additively manufactured, the transmission of the component identification information, and/or the transmission of the component information.

The additive manufacturing device 20 can be released or blocked in dependence on the received release information for additively manufacturing the component by means of the manufacturing material product unit (for example F2), which is identified by the transmitted product identification information.

Upon release, the corresponding one of the manufacturing material product units (for example F2) can be inserted into the additive manufacturing device 20 or connected to the additive manufacturing device 20. It is also possible to connect the corresponding one of the manufacturing material product units (for example F2) already beforehand to the additive manufacturing device 20. The component can then be additively manufactured by means of the additive manufacturing device 20 using the manufacturing material product unit (for example F2), which is identified by the transmitted product identification information.

During the additive manufacturing, the additive manufacturing device 20 can preferably be operated in dependence on the at least one operating parameter received, if desired.

The first system 28 can transmit a material consumption information and/or a production progress information to the second system 30. The material consumption information can specify, for example, an acquired or estimated material consumption of the manufacturing material product unit (for example F2) during the additive manufacturing of the component from the manufacturing material product unit (for example F2), which is identified by the transmitted product identification information. The production progress information can specify, for example, a production progress and/or a completion of the component to be additively manufactured.

The second system 30 can receive the transmitted material consumption information and/or the transmitted production progress information.

The second system 30 can update the actual product material amount information in dependence on the received material consumption information and/or the received production progress information. Thus, for example, the actual product material amount information can be reduced by that material amount which is specified by the received material consumption information or by the setpoint product material amount information if the production progress information specifies that the component to be additively manufactured has been completely produced.

Alternatively or additionally, the second system 30 can update the actual product material amount information and, for example, reduce it by the setpoint product material amount information if the step of checking was successful or if the transmission of the release information to the first system 28 has been carried out or has been acknowledged by the first system 28.

It is possible that if the inventory falls below a predefinable minimum inventory in the virtual warehouse, an inventory information or order request information is automatically transmitted by the second system 30 to the first system 28.

The invention is not restricted to the above-described preferred exemplary embodiments. Rather, a large number of variants and modifications are possible, which also make use of the concept of the invention and therefore fall in the scope of protection. In particular, the invention also claims protection for the subject matter and the features of the dependent claims independently of the claims referred to. In particular, the individual features of the independent claims are each disclosed independently of one another. In addition, the features of the dependent claims are also disclosed independently of all features of the independent claims.

### LIST OF REFERENCE SIGNS

10 industrial facility
12 industrial facility
14 supplier
16 warehouse
18 computing infrastructure
20 additive manufacturing device
22 warehouse
24 computing infrastructure
26 cloud infrastructure
28 first system
30 second system
F1-F3 manufacturing product material unit

1. A method for operating an additive manufacturing device for additively manufacturing a component, including:
transmitting a product identification information that identifies a manufacturing material product unit; and
receiving a release information to release the additive manufacturing device in reaction to the transmitting of the product identification information.

2. The method according to claim 1, wherein the manufacturing material product unit is one of a material filament spool, a container having liquid material, and a container having powdered material.

3. The method according to claim 1, further including releasing the additive manufacturing device for additively manufacturing the component via the manufacturing material product unit that is identified by the product identification information, in dependence on the received release information.

4. The method according to claim 3, further including additively manufacturing the component by means of the manufacturing material product unit (F2), which is identified by the product identification information, by way of the released additive manufacturing device.

5. The method according to claim 1, further including:
inputting, acquiring, or selecting the product identification information before the transmission of the product identification information.

6. The method according to claim 5, wherein one of:
the product identification information is input via a user interface;
the product identification information is acquired via one of a sensor system and a communication interface; and
the product identification information is selected via a user interface.

7. The method according claim 1, wherein:
the manufacturing material product unit is selected from a plurality of manufacturing material product units, which are each identified by a product identification information for identifying the respective manufacturing material product unit.

8. The method according to claim 1, further including at least one of the following:
selecting a component to be additively manufactured in an operating interface, the component being identified via a component identification information;
transmitting a component identification information, which identifies a component selected for additive manufacturing; and
transmitting a component information, which specifies at least one a geometry feature and a material specification feature of a component selected for additive manufacturing.

9. The method according to claim 8, wherein:
the receiving of the release information further takes place in reaction to the at least one of the selection of the component to be additively manufactured, the transmission of the component identification information, and the transmission of the component information.

10. The method according to claim 1, further including at least one of the following:
transmitting a material consumption information, which specifies an acquired or estimated material consumption of the manufacturing material product unit during the additive manufacturing of the component from the manufacturing material product unit;
transmitting a production progress information, which specifies at least one of a production progress and a completion of the component to be additively manufactured; and
receiving at least one operating parameter for operating the additive manufacturing device in reaction to the transmission of the product identification information.

11. The method according to claim 1, further including receiving at least one operating parameter for operating the additive manufacturing device in reaction to the transmission of the product identification information and operating the additive manufacturing device in dependence on the at least one operating parameter received.

12. A method for monitoring operation of an additive manufacturing device for additively manufacturing a component, including:
receiving a product identification information, which identifies a manufacturing material product unit;
checking at least one of the received product identification information and at least one information assigned to the received product identification information; and
transmitting a release information in dependence on the checking.

13. The method according to claim 12, wherein:
when checking the product identification information, the product identification information is checked for reliability, for at least one of a correspondence with an entry in a list of permissible product identification information, and a presence in a virtual warehouse.

14. The method according to claim 12, further including:
retrieving an actual product information, which is assigned to the received product identification information, wherein the retrieved actual product information is checked.

15. The method according to claim 14, wherein the actual product information assigned to the received product identification information is retrieved from a database.

16. The method according to claim 14, wherein:
the checking of the retrieved actual product information includes checking of at least one of an actual product material amount information of the actual product information and an actual product material specification information of the actual product information.

17. The method according to claim 14, wherein:
the checking of the retrieved actual product information takes place with respect to a setpoint product information, the setpoint product information including at least one of a setpoint product material amount information and a setpoint product material specification information.

18. The method according to claim 14, further including:
updating the actual product information in dependence on at least one of:
the checking;
the transmitting;
receiving of a material consumption information;
receiving of a production progress information; and
a setpoint product material amount information.

19. The method according to claim 12, further including at least one of the following:
receiving at least one of a component identification information, which identifies a component selected for additive manufacturing, and a component information, which specifies at least one of a geometry feature and a material feature of a component selected for additive manufacturing, wherein the setpoint product information is dependent on at least one of the received component identification information and the received component information;
transmitting at least one operating parameter for the operation of the additive manufacturing device, wherein the at least one operating parameter is dependent on the received product identification information; and
transmitting one of an inventory information and an order request information when an inventory in a virtual warehouse reaches or falls below a predefinable minimum inventory.

20. A system which is configured to carry out a method according to claim 1.
